(19) United States
(12) Patent Application Publication
(10) Pub. No.: US 2026/0322205 A1
(43) Pub. Date: Oct. 15, 2026

(54) ROTATING ELECTRIC MACHINE SYSTEM

(71) Applicant: HONDA MOTOR CO., LTD., Tokyo (JP)

(72) Inventors: Daijiro Eto, Wako-shi (JP); Yuki Wada, Wako-shi (JP); Rintaro Tanaka, Wako-shi (JP); Motoshi Togasaki, Wako-shi (JP); Keita Chinzaka, Wako-shi (JP); Kenta Yamazaki, Wako-shi (JP)

(21) Appl. No.: 19/463,935

(22) Filed: Jan. 29, 2026

(30) Foreign Application Priority Data
Feb. 3, 2025 (JP) 2025-015988

(51) Int. Cl. H02K 5/173; F16C 33/66; H02K 7/18; H02K 21/14

(52) U.S. Cl. CPC H02K 5/1732; F16C 33/6659; F16C 33/6681; H02K 7/1823; H02K 21/14; F16C 2380/26

(57) ABSTRACT

A rotating electric machine housing of a rotating electric machine system is equipped with a first bearing chamber that accommodates a first bearing. In the first bearing chamber, a first oil nozzle having a first delivery port through which the lubricating oil is discharged toward the first bearing, and an oil scattering prevention cover that covers the first bearing so as to face the first bearing in an axial direction. The first delivery port is disposed inside the oil scattering prevention cover.

### CROSS-REFERENCE TO RELATED APPLICATIONS

This application is based upon and claims the benefit of priority from Japanese Patent Application No. 2025-015988 filed on Feb. 3, 2025, the contents of which are incorporated herein by reference.

### BACKGROUND OF THE INVENTION

### FIELD OF THE INVENTION

The present disclosure relates to a rotating electric machine system.

### DESCRIPTION OF THE RELATED ART

In JP 2024-025367 A discloses a rotating electric machine system including a rotor and a stator. Bearings that rotatably support the rotor are disposed in the rotating electric machine system. A lubricating oil is supplied to the bearings.

### SUMMARY OF THE INVENTION

When the lubricating oil is delivered or ejected toward the bearing in a bearing chamber in which the bearing is accommodated, the lubricating oil is repelled by the bearing rotating at high speed, and thus the lubricating oil is scattered in the bearing chamber. In this case, there is a concern that the efficiency of collecting the lubricating oil from the bearing chamber may be reduced.

The present disclosure has the object of solving the aforementioned problem.

An aspect of the present disclosure is characterized by a rotating electric machine system, including a rotating electric machine including a rotor, the rotor including a permanent magnet and a rotating shaft, a rotating electric machine housing configured to rotatably support the rotating shaft, a first bearing and a second bearing each interposed between the rotating electric machine housing and the rotating shaft, and configured to be mutually spaced apart from each other in an axial direction of the rotor, a first bearing chamber provided in the rotating electric machine housing and configured to accommodate the first bearing, a first oil nozzle provided in the first bearing chamber and including a first delivery port through which a lubricating oil is delivered toward the first bearing, an oil circulation supply device configured to recover the lubricating oil from the first bearing chamber and supply the lubricating oil to an oil supply path provided in the rotating electric machine housing, and an oil scattering prevention cover provided in the first bearing chamber and configured to cover the first bearing so as to face the first bearing in the axial direction, wherein the first delivery port is disposed inside the oil scattering prevention cover.

According to the rotating electric machine system of the present disclosure, the lubricating oil repelled by the first bearing rotating at high speed is prevented from scattering in the first bearing chamber, and the entrainment and lifting of the lubricating oil by the swirling airflow accompanying the rotation of the rotor is also suppressed. Therefore, the gas-liquid separation efficiency in the first bearing chamber is improved, and the lubricating oil can be efficiently recovered. In addition, the load of the pump or the like used to recover the lubricating oil is reduced, which can contribute to the reduction in size and weight of the pump or the like.

The above and other objects, features, and advantages of the present invention will become more apparent from the following description when taken in conjunction with the accompanying drawings, in which a preferred embodiment of the present invention is shown by way of illustrative example.

### BRIEF DESCRIPTION OF THE DRAWINGS

FIG. 1 is a perspective view of a combined motive power system;

FIG. 2 is a schematic cross-sectional view of a rotating electric machine system;

FIG. 3 is a schematic cross-sectional view of the rotating electric machine system as viewed from another angle;

FIG. 4 is an enlarged cross-sectional view in the vicinity of a first bearing;

FIG. 5 is an enlarged cross-sectional view in the vicinity of a second bearing;

FIG. 6 is a conceptual diagram of an oil circulation supply device in the rotating electric machine system; and

FIG. 7 is a configuration diagram of an oil scattering prevention cover and its surrounding vicinity.

### DETAILED DESCRIPTION OF THE INVENTION

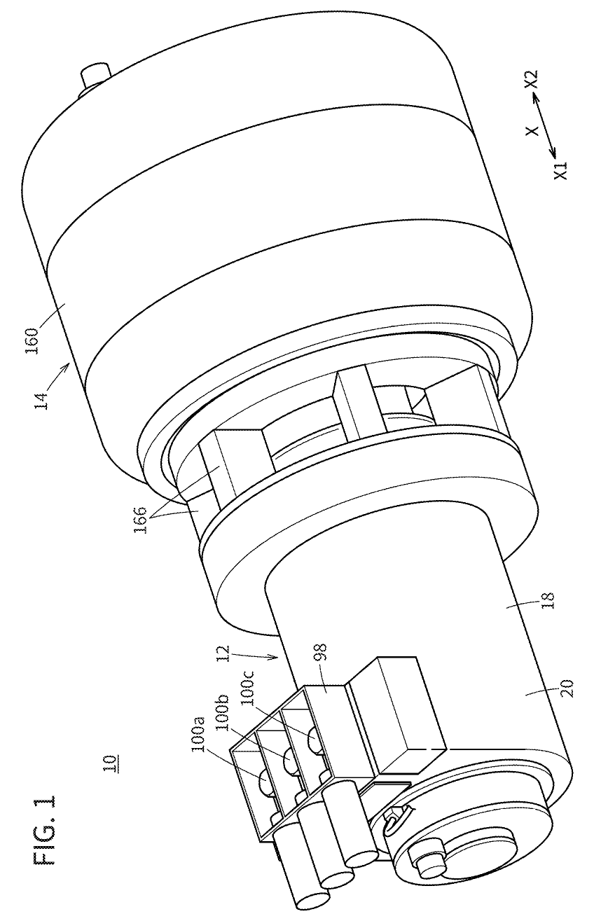

A combined motive power system 10 shown in FIG. 1 includes a rotating electric machine system 12 according to the present embodiment, and a gas turbine engine 14. An axial line of the rotating electric machine system 12 and an axial line of the gas turbine engine 14 coincide with each other. Stated otherwise, the rotating electric machine system 12 and the gas turbine engine 14 are disposed in series on the same axial line.

The combined motive power system 10 is used, for example, as a motive power source for providing propulsion in a flying object, a ship, an automobile, or the like. Suitable specific examples of the flying object include drones or multi-copters. The combined power system 10, when mounted on a flying object, is used as a power drive source for rotating, for example, a prop, a ducted fan, or the like. The combined power system 10, when mounted on a ship, is used as a screw rotational force generating device. The combined power system 10, when mounted on an automobile, is used as a power drive source for rotating a motor.

The combined power system 10 can also be used as an auxiliary power source in an aircraft, a ship, a building, or the like. Apart therefrom, it is also possible to utilize the combined motive power system 10 as gas turbine power generation equipment. The gas turbine engine 14 is an internal combustion engine.

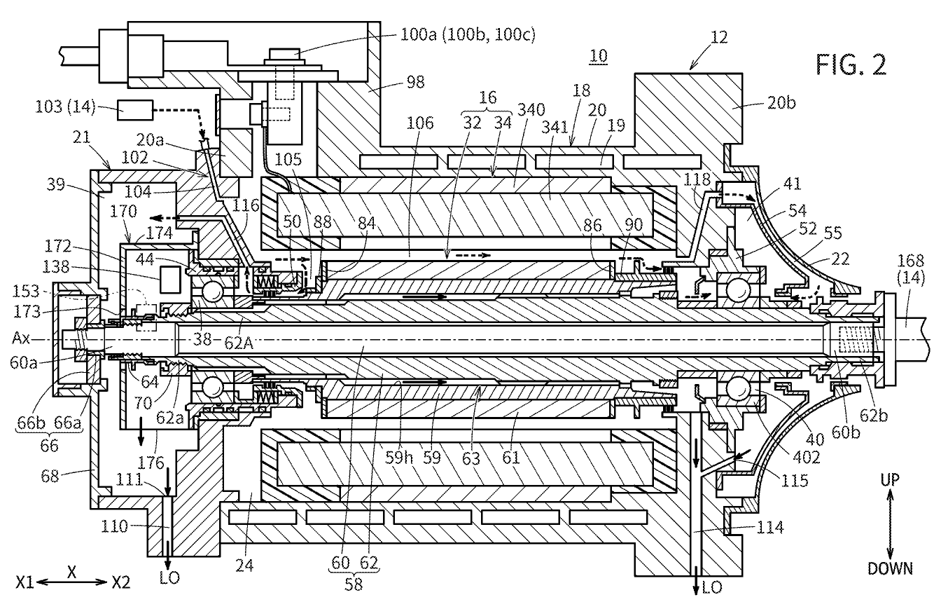

In the following description, the respective terms "lower" and "upper" refer specifically to the lower and the upper directions shown in FIG. 2.

As shown in FIG. 2, the rotating electric machine system 12 includes a rotating electric machine 16 and a rotating electric machine housing 18. In the present embodiment, the rotating electric machine 16 is a generator. The rotating electric machine 16 includes a rotor 32 and a stator 34.

The rotating electric machine housing 18 accommodates the rotating electric machine 16. The rotating electric machine housing 18 includes a main housing 20, a first sub-housing 21, and a second sub-housing 22. The main housing 20 has a generally cylindrical shape in which both ends thereof are open. The main housing 20 includes an accommodation chamber 24 that serves to accommodate the rotating electric machine 16. A cooling jacket 19 is formed in the interior of a circumferential wall part of the main housing 20. A liquid coolant such as cooling water or the like flows through the cooling jacket 19.

The first sub-housing 21 is connected to a first housing end 20a, which is an end part on a side in the X1 direction of the main housing 20, and thereby closes an opening of the first housing end 20a. The second sub-housing 22 is connected to a second housing end 20b, which is an end part on a side in the X2 direction of the main housing 20, and thereby closes an opening of the second housing end 20b.

The rotor 32 is supported, via a first bearing 38 and a second bearing 40, to be capable of rotating with respect to the rotating electric machine housing 18. Next, a description will be given concerning the first bearing 38, the second bearing 40, and the surrounding structure thereof.

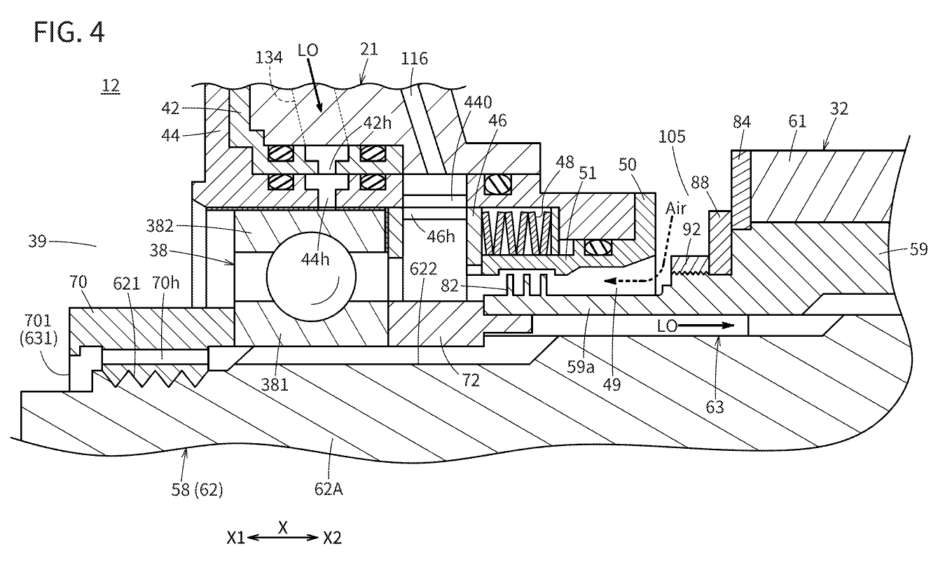

As shown in FIG. 4, a hollow cylindrically shaped holder spacer 42 and a hollow cylindrically shaped first bearing holder 44 are inserted into an inner peripheral part of the first sub-housing 21. The first bearing 38 is disposed on an inner side of the first bearing holder 44. A hollow portion of the first sub-housing 21 forms a first bearing chamber 39 in which the first bearing 38 is accommodated. A lubricating oil LO is supplied to the first bearing 38, via an oil supplying hole 42h that is formed in the holder spacer 42, and an oil supplying hole 44h that is formed in the first bearing holder 44.

The first bearing holder 44 includes a plurality of oil drainage holes 440. The plurality of oil drainage holes 440 are holes for the purpose of discharging the lubricating oil LO that was supplied to the first bearing 38 to the exterior of the first bearing holder 44.

A spacer ring 46 is positioned and fixed inside an interior of the first bearing holder 44. The spacer ring 46 has a plurality of relay holes 46h. The plurality of relay holes 46h are formed at intervals in the circumferential direction of the spacer ring 46.

A preload applying member 48, via the spacer ring 46, applies a load (a preload) to an outer ring 382 of the first bearing 38. A direction of the load is an axial direction (an X direction) of the rotor 32. The preload applying member 48 is constituted, for example, by a plurality of disc springs.

A holder member 50 is mounted on an end part on a side in the X2 direction of the first bearing holder 44. The holder member 50 is fixed to the first bearing holder 44, and therefore, is a non-rotating part. The holder member 50 serves to retain the preload applying member 48. The holder member 50 includes a hollow cylindrically shaped holder cylinder part 51. The preload applying member 48 is disposed in an annular space that is formed between the first bearing holder 44 and the holder cylinder part 51.

As shown in FIG. 2, an annular shaped second bearing holder 52 is mounted on the second housing end 20b (an end part on a side in the X2 direction) of the main housing 20. The second bearing holder 52 is connected via bolts or the like to the main housing 20. An outer ring 402 of the second bearing 40 is retained on an inner circumferential part of the second bearing holder 52. A flow path forming member 54 is fixed to an end part on a side in the X2 direction of the main housing 20. The flow path forming member 54 covers the second bearing 40. A hollow portion of the flow path forming member 54 forms a second bearing chamber 41 in which the second bearing 40 is accommodated.

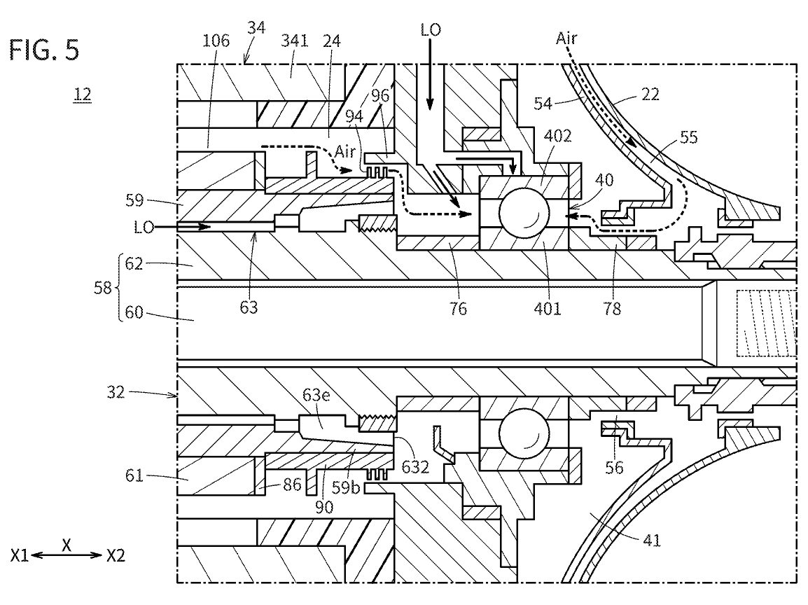

The rotor 32 includes a rotating shaft 58, a sleeve 59, and permanent magnets 61. The sleeve 59 surrounds the rotating shaft 58, and the permanent magnets 61 surround the sleeve 59. A rotor internal flow path 63 is formed in the interior of the rotor 32. According to the present embodiment, the lubricating oil LO flows as a liquid coolant through the rotor internal flow path 63. The lubricating oil LO flows through the rotor internal flow path 63 from an inlet 631 (refer to FIG. 4) toward an outlet 632 (refer to FIG. 5) of the rotor internal flow path 63. More specifically, the lubricating oil LO flows in the X2 direction through the rotor internal flow path 63. Therefore, concerning the rotor internal flow path 63, the side in the X1 direction is an upstream side, and the side in the X2 direction is a downstream side. The rotor internal flow path 63 gradually expands in diameter in a stepwise manner toward the downstream side.

The rotating shaft 58, together with being supported to be capable of rotating by the first sub-housing 21 via the first bearing 38, is supported to be capable of rotating by the main housing 20 via the second bearing 40. The rotating shaft 58 includes an inner shaft 60, and an outer shaft 62.

The inner shaft 60 includes a first inner shaft end 60a, which is an end part on a side in the X1 direction, and a second inner shaft end 60b, which is an end part on a side in the X2 direction. The outer shaft 62 includes a first outer shaft end 62a, which is an end part on a side in the X1 direction, and a second outer shaft end 62b, which is an end part on a side in the X2 direction. The inner shaft 60 is inserted into an inner part of the outer shaft 62. The inner shaft 60 is longer than the outer shaft 62.

The first inner shaft end 60a projects out in the X1 direction from the first outer shaft end 62a. The first inner shaft end 60a, by means of a fastening structure including a nut member 64 or the like, is connected to the first outer shaft end 62a.

A resolver rotor 66a is fixed to the first inner shaft end 60a. A resolver stator 66b is disposed in a manner so as to surround the resolver rotor 66a. The resolver stator 66b is retained by a resolver holder 68 that is mounted in the first sub-housing 21. The resolver rotor 66a and the resolver stator 66b constitute a resolver 66.

The outer shaft 62 is a hollow cylindrical member. As shown in FIG. 4, the outer shaft 62 defines the rotor internal flow path 63 between a fastening ring 70, the first bearing 38, a support member 72, and the sleeve 59.

As shown in FIG. 4, an inner ring 381 of the first bearing 38 is supported by a first shaft portion 62A that constitutes an end part on a side in the X1 direction of the outer shaft 62. An outer circumferential part of the first shaft portion 62A includes a male thread 621, and a plurality of flow path grooves 622.

The fastening ring 70 is screwed onto the male thread 621 of the first shaft portion 62A. The fastening ring 70 constitutes one part of the rotor 32. The inner ring 381 of the first bearing 38 is sandwiched between the fastening ring 70 and the support member 72 in an axial direction (the X direction) of the rotor 32. The support member 72 is an inner ring stopper. In accordance with this feature, the inner ring 381 of the first bearing 38 is fixed to a predetermined location on the outer circumferential surface of the outer shaft 62.

The fastening ring 70 includes a plurality of communication holes 70h disposed mutually at intervals in the circumferential direction. The plurality of communication holes 70h penetrate in the axial direction through an inner circumferential part of the fastening ring 70. An annular opening 701 that is disposed on a side in the X1 direction of the fastening ring 70 serves as the inlet 631 of the rotor internal flow path 63. An end surface of the fastening ring 70 on a side in the X2 direction abuts against the inner ring 381 of the first bearing 38. The plurality of communication holes 70h constitute one part of the rotor internal flow path 63.

The plurality of flow path grooves 622 are disposed more on a downstream side than the plurality of communication holes 70h that are formed in the fastening ring 70. The plurality of flow path grooves 622 are formed mutually at intervals from one another in the circumferential direction of the outer shaft 62. Each of the flow path grooves 622 is recessed inwardly in a radial direction from the outer circumferential surface of the outer shaft 62, and extends in the axial direction of the rotor 32. The plurality of flow path grooves 622 constitute one part of the rotor internal flow path 63. The inner ring 381 of the first bearing 38 is disposed in a manner so as to surround the plurality of flow path grooves 622.

The support member 72 is an annular member that is disposed between the inner ring 381 of the first bearing 38 and the sleeve 59. A part of the rotor internal flow path 63 is formed between the outer shaft 62 and the support member 72. The support member 72 is fixed to the outer shaft 62, for example, by press fitting. The support member 72 is supported by an outer circumferential part of the outer shaft 62. The support member 72 is disposed in a manner so as to surround the plurality of flow path grooves 622. The support member 72 lies adjacent to the inner ring 381 of the first bearing 38, and further, supports a first sleeve end part 59a which is one end part of the sleeve 59. A part of the rotor internal flow path 63 is formed between the outer shaft 62 and the sleeve 59.

As shown in FIG. 5, an outlet space 63e of the rotor internal flow path 63 is formed between the outer shaft 62 and a second sleeve end part 59b.

An inner side inner ring stopper 76, an inner ring 401 of the second bearing 40, and an outer side inner ring stopper 78 are supported by an outer circumferential surface of the outer shaft 62. The inner ring 401 of the second bearing 40 is sandwiched from both sides in the axial direction between the inner side inner ring stopper 76 and the outer side inner ring stopper 78. In accordance with this feature, the inner ring 401 of the second bearing 40 is fixed to a predetermined location on the outer circumferential surface of the outer shaft 62.

As shown in FIG. 2, the sleeve 59 is a hollow cylindrical member having an inner hole 59h. The rotating shaft 58 is inserted into the inner hole 59h of the sleeve 59. A major portion of the rotor internal flow path 63 is formed by the sleeve 59 and the rotating shaft 58. The sleeve 59 surrounds the rotating shaft 58.

As shown in FIG. 4, a seal member 82 is disposed on an outer peripheral part of the first sleeve end part 59a. The seal member 82 is a labyrinth seal having a plurality of projections that are spaced apart from one another in the axial direction.

The holder member 50 is a hollow cylindrically shaped portion that is disposed outwardly in a radial direction of the first sleeve end part 59a. Therefore, the holder member 50 faces toward the seal member 82 in the radial direction, and surrounds the seal member 82. A gap is formed between the seal member 82 and the holder member 50 (the holder cylinder part 51). The preload applying member 48 is disposed in a manner so as to surround the holder member 50, the seal member 82, and the support member 72. The first sleeve end part 59a is inserted into an inner side of the holder member 50. An annular gap 49 is formed between the first sleeve end part 59a and the holder member 50.

The sleeve 59 is fixed, for example, by shrink fitting, to an outer surface of the rotating shaft 58. The permanent magnets 61 are retained in the sleeve 59. In the present aspect, the rotor 32 is a so-called SPM (surface permanent magnet motor) type in which the permanent magnets 61 are disposed on the outer circumferential surface of the sleeve 59. Alternatively, the rotor 32 may be of a so-called IPM (interior permanent magnet motor) type in which the permanent magnets 61 are embedded in the sleeve 59.

As shown in FIG. 2, a first ring body 84 abuts against end surfaces of the permanent magnets 61 on a side in the X1 direction. A second ring body 86 abuts against end surfaces of the permanent magnets 61 on a side in the X2 direction. The first ring body 84, the permanent magnets 61, and the second ring body 86 are sandwiched between a pair of magnet stoppers 88 and 90 in the axial direction of the rotor 32. Hereinafter, the magnet stopper 88 on the side in the X1 direction will be referred to as a "first magnet stopper 88", and the magnet stopper 90 on the side in the X2 direction will be referred to as a "second magnet stopper 90".

The first magnet stopper 88 is fixed by a fixing ring 92 (refer to FIG. 4) that is screwed onto the sleeve 59. The second magnet stopper 90 is fixed to the second sleeve end part 59b (refer to FIG. 5). The second sleeve end part 59b is another end part in the axial direction of the sleeve 59. The first magnet stopper 88 and the second magnet stopper 90 are fixed, for example, by shrink fitting, to an outer peripheral part of the sleeve 59. In accordance with this feature, the permanent magnets 61 are fixed to the outer circumferential surface of the sleeve 59.

As shown in FIG. 5, a seal member 94 is disposed on an outer peripheral part of the second magnet stopper 90. The seal member 94 is a labyrinth seal having a plurality of projections that are spaced apart from one another in the axial direction.

The seal member 94 faces in a radial direction on an annular shaped projection 96 that is disposed on the main housing 20. A gap is formed between the seal member 94 and the annular shaped projection 96.

The second sleeve end part 59b forms the outlet space 63e of the rotor internal flow path 63 between itself and the outer shaft 62. An inner diameter of the second sleeve end part 59b becomes larger toward the X2 direction. A downstream end of the outlet space 63e (an opening of the sleeve 59 on a side in the X2 direction) is the outlet 632 of the rotor internal flow path 63.

As shown in FIG. 2, the stator 34 includes a stator core 340, and a plurality of electromagnetic coils 341. The stator core 340 is a tubular shaped member. The stator core 340 is constituted, for example, by laminating a plurality of ring-shaped electromagnetic steel plates in the axial direction. A plurality of slots are formed in the stator core 340. Teeth portions are formed between adjacent ones of the slots.

The plurality of electromagnetic coils 341 include a U-phase coil, a V-phase coil, and a W-phase coil. Therefore, in the case that the rotating electric machine 16 is a generator, the rotating electric machine 16 is a so-called three-phase electrical power source. Each of the plurality of electromagnetic coils 341 is constituted by winding a conductive wire around teeth portions of the stator core 340.

As shown in FIG. 1, a terminal casing 98 is integrally disposed on an upper surface on a side in the X1 direction of the main housing 20. As shown in FIG. 2, a U-phase terminal 100a, a V-phase terminal 100b, and a W-phase terminal 100c are accommodated inside the terminal casing 98. The U-phase terminal 100a, the V-phase terminal 100b, and the W-phase terminal 100c are electrically connected respectively to the U-phase coil, the V-phase coil, and the W-phase coil of the stator 34.

As shown in FIG. 2, a gaseous coolant flow path structure 102 is provided in the rotating electric machine system 12. The gaseous coolant flow path structure 102 is a structure for the purpose of circulating a gas via the rotor 32 (particularly, the permanent magnets 61) and the stator 34. At this time, the rotor 32 and the stator 34 are capable of being cooled by a cooling gas. In the following description, air will be illustrated as an example of the cooling gas. The air is supplied from a gas supply device 103. Moreover, as will be discussed later, the air that is supplied to the rotating electric machine housing 18 forms an air curtain in order to prevent the lubricating oil LO from entering the accommodation chamber 24. Therefore, the gaseous coolant flow path structure 102 also serves in a dual manner as a sealing air flow path structure.

The gaseous coolant flow path structure 102 includes a gas supply path 104, a first branching path 105, and a second branching path 106. An air supply port, which serves as an inlet to the gas supply path 104, is disposed on an outer surface of the first sub-housing 21. The first branching path 105 and the second branching path 106 are one portion of the accommodation chamber 24.

The gas supply path 104 is formed in the first sub-housing 21. The air that has passed through the gas supply path 104 flows into the accommodation chamber 24 of the main housing 20. The air that has flowed into the accommodation chamber 24 is divided into the first branching path 105 and the second branching path 106.

The first branching path 105 is a flow path that directs the air toward the first bearing 38. As shown in FIG. 4, the air that has passed through the first branching path 105 flows into the annular gap 49 that is formed between the holder member 50 and the sleeve 59, and flows in the X1 direction through this annular gap 49. In this manner, the air that flows toward the first bearing 38 forms an air curtain. The air curtain prevents the lubricating oil LO from entering the accommodation chamber 24 in which the rotor 32 is accommodated. Thereafter, via the relay holes 46h that are provided in the spacer ring 46, the air flows into a flow path 116 that is formed in the first sub-housing 21. As shown in FIG. 2, the air that has passed through the flow path 116 flows into the first bearing chamber 39 which is a hollow portion of the first sub-housing 21.

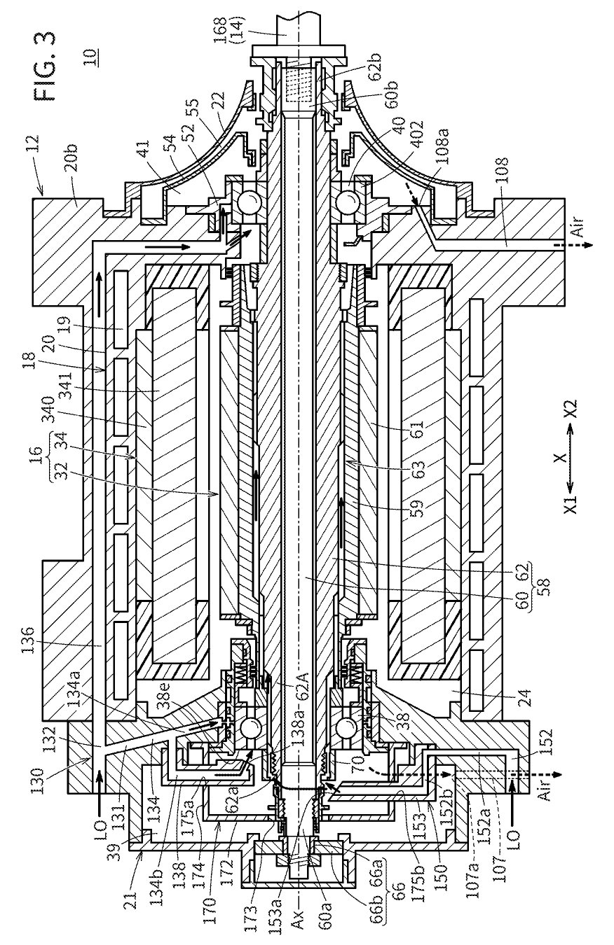

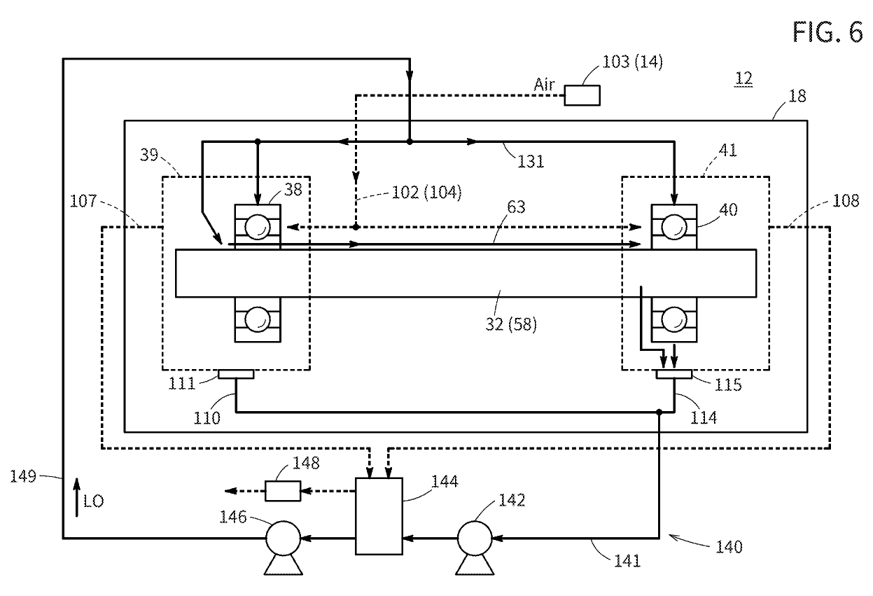

As shown in FIG. 3, the air is discharged, via a gas discharge path 107 (hereinafter referred to as a "first gas discharge path 107"), from the first bearing chamber 39. The first gas discharge path 107 is formed in the first sub-housing 21. The gas inlet (a first vent opening 107a) of the first gas discharge path 107 is formed in an upper part of the first bearing chamber 39. Moreover, concerning the term "upper part" of the first bearing chamber 39, the term signifies a region of the first bearing chamber 39 that is more upward than the axis (a rotation axis Ax of the rotor 32) of the rotating electric machine system 12. Therefore, the first vent opening 107a may be formed more downward than an uppermost part of the first bearing chamber 39. The air that is discharged via the first gas discharge path 107 is introduced into a tank 144 (refer to FIG. 6).

The second branching path 106 is a clearance that extends along the axial direction of the rotor 32 between the rotor 32 and the stator 34. The second branching path 106 is a flow path that directs the air toward the second bearing 40. As shown in FIG. 5, a portion of the air that has passed through the second branching path 106 flows into an outer circumference side of the inner side inner ring stopper 76, and flows toward the second bearing 40. In this manner, the air that flows toward the second bearing 40 forms an air curtain. The air curtain prevents the lubricating oil LO from entering the accommodation chamber 24 in which the rotor 32 is accommodated.

As shown in FIG. 2, the remainder of the air that has passed through the second branching path 106 flows into an air distribution path 118 that is formed in the main housing 20. The air that has passed through the air distribution path 118 flows into a flow path 55 that is formed between the second sub-housing 22 and the flow path forming member 54. An outer circumferential part of the flow path forming member 54 is fixed to the main housing 20 on an inner side of the second sub-housing 22. As shown in FIG. 5, an annular shaped ventilation path 56 is formed between an inner peripheral part of the flow path forming member 54 and an outer peripheral part of the outer side inner ring stopper 78. The air that has passed through the flow path 55 flows, via the flow path 55 and the ventilation path 56, into the second bearing chamber 41, and toward the second bearing 40.

As shown in FIG. 3, the air is discharged, via a gas discharge path 108 (hereinafter referred to as a "second gas discharge path 108") that is formed in the rotating electric machine housing 18, from the second bearing chamber 41. The gas inlet (a second vent opening 108a) of the second gas discharge path 108 is formed in an upper part of the second bearing chamber 41. Moreover, concerning the term "upper part" of the second bearing chamber 41, the term signifies a region of the second bearing chamber 41 that is more upward than the rotation axis Ax of the rotor 32. Accordingly, the second vent opening 108a may be formed more downward than an uppermost part of the second bearing chamber 41. The air that is discharged via the second gas discharge path 108 is introduced into the tank 144 (refer to FIG. 6).

As shown in FIG. 3, a lubricating oil flow path structure 130 and a rotor cooling structure 150 are further provided in the rotating electric machine system 12. The lubricating oil flow path structure 130 is a flow path in order to supply the lubricating oil LO to the first bearing 38 and the second bearing 40.

The lubricating oil flow path structure 130 includes a lubricating oil introduction path 132, a first distribution path 134, a first drain path 110 (FIG. 2, an oil discharge path), a second distribution path 136, and a second drain path 114 (FIG. 2, an oil discharge path). The lubricating oil introduction path 132, the first distribution path 134, and the second distribution path 136 make up an oil supply path 131 that is disposed in the rotating electric machine housing 18. The lubricating oil LO is supplied from an oil circulation supply device 140 to the lubricating oil introduction path 132. The lubricating oil introduction path 132, in the interior of the first sub-housing 21, branches into the first distribution path 134 and the second distribution path 136.

The first distribution path 134 is formed in the first sub-housing 21. The lubricating oil LO is supplied via the first distribution path 134 to the first bearing 38. The first distribution path 134 includes a first line 134a and a second line 134b. The first line 134a is a flow path through which the lubricating oil LO is supplied toward an outer circumferential part of the first bearing 38. The second line 134b is a flow path through which the lubricating oil LO is supplied toward an end surface 38e on a side in the X1 direction of the first bearing 38.

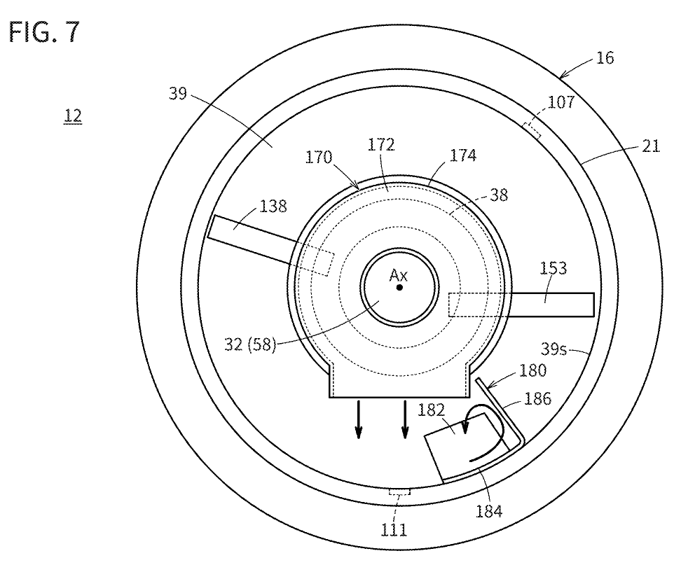

The second line 134b is formed in a first oil nozzle 138. The first oil nozzle 138 is fixed to the first sub-housing 21, and is disposed within the first bearing chamber 39. One end part of the first oil nozzle 138 is fixed to the first sub-housing 21. The first oil nozzle 138 extends toward the rotor 32 (also refer to FIG. 7). A first delivery port 138a that delivers the lubricating oil LO toward the end surface 38e of the first bearing 38 is disposed on another end of the first oil nozzle 138. The first delivery port 138a faces the end surface 38e of the first bearing 38 in the vicinity of the end surface 38e.

As shown in FIG. 2, the lubricating oil LO that is supplied to the first bearing 38 is discharged from the first bearing chamber 39 via the first drain path 110 that is formed in the rotating electric machine housing 18. An upstream end of the first drain path 110 is an oil discharge port 111 (hereinafter referred to as a "first oil discharge port 111") that discharges the lubricating oil LO from the first bearing chamber 39. The first oil discharge port 111 is disposed on a lower part of the first bearing chamber 39. The first oil discharge port 111 may be disposed in any position that enables the discharge port to draw in the lubricating oil LO that is stored in the first bearing chamber 39. Therefore, the first oil discharge port 111 need not necessarily be the lowermost part of the first bearing chamber 39.

Moreover, as noted previously, an air curtain is formed in the vicinity of the first bearing 38. Therefore, a situation is suppressed in which the lubricating oil LO that is supplied to the first bearing 38 enters the accommodation chamber 24 via the annular gap 49 (refer to FIG. 4).

As shown in FIG. 3, the second distribution path 136 of the lubricating oil flow path structure 130 is formed in the main housing 20. The lubricating oil LO is supplied via the second distribution path 136 to the second bearing 40. The lubricating oil LO that is supplied to the second bearing 40 is discharged from the second bearing chamber 41 via the second drain path 114 that is formed in the rotating electric machine housing 18.

As shown in FIG. 2, an upstream end of the second drain path 114 is an oil discharge port 115 (hereinafter referred to as a "second oil discharge port 115") that discharges the lubricating oil LO from the second bearing chamber 41. The second oil discharge port 115 is disposed on a lower part of the second bearing chamber 41. The second oil discharge port 115 may be disposed in any position that enables the discharge port to draw in the lubricating oil LO that is stored in the second bearing chamber 41. Therefore, the second oil discharge port 115 need not necessarily be the lowermost part of the second bearing chamber 41.

Moreover, as noted previously, an air curtain is formed in the vicinity of the second bearing 40. Therefore, a situation is suppressed in which the lubricating oil LO that is supplied to the second bearing 40 enters the accommodation chamber 24.

As shown in FIG. 3, the rotor cooling structure 150 is a flow path in order to supply the lubricating oil LO into the rotor 32, and thereby cool the permanent magnets 61. The rotor cooling structure 150 includes a supply path 152, the aforementioned rotor internal flow path 63, and the second drain path 114. The supply path 152 supplies the lubricating oil LO to the rotor internal flow path 63. The supply path 152 has an introduction path 152a that is formed in the first sub-housing 21, and a guide path 152b that is formed in a second oil nozzle 153.

The guide path 152b communicates with the introduction path 152a. The second oil nozzle 153 is disposed in the first bearing chamber 39. One end of the second oil nozzle 153 is fixed to the first sub-housing 21. The second oil nozzle 153 extends toward the rotor 32 (also refer to FIG. 7). A second delivery port 153a, which is an outlet of the guide path 152b, is formed in another end of the second oil nozzle 153. The second delivery port 153a, in the vicinity of the inlet 631 (refer to FIG. 4) of the rotor internal flow path 63, faces toward the inlet 631. The lubricating oil LO that is discharged from the second delivery port 153a, as shown in FIG. 4, flows via the annular opening 701 (the inlet 631) of the fastening ring 70 into the rotor internal flow path 63.

As shown in FIG. 6, the oil circulation supply device 140 is further provided in the rotating electric machine system 12. The oil circulation supply device 140, together with recovering the lubricating oil LO from the first bearing chamber 39 and the second bearing chamber 41, supplies the lubricating oil LO to the oil supply path 131 that is provided in the rotating electric machine housing 18. The oil circulation supply device 140 is equipped with a recovery pump 142, the tank 144, a supply pump 146, and a gas-liquid separator 148. The lubricating oil LO is sucked from the first bearing chamber 39 and the second bearing chamber 41 through the first drain path 110 and the second drain path 114 by driving the recovery pump 142. The lubricating oil LO that is drawn in flows via a recovery line 141 into the tank 144.

The tank 144 stores the lubricating oil LO that is discharged (recovered) from the first bearing chamber 39 and the second bearing chamber 41. Further, the air that is discharged from the first bearing chamber 39 and the second bearing chamber 41 is introduced into the tank 144 via the first gas discharge path 107 and the second gas discharge path 108. The air that is discharged from the first bearing chamber 39 and the second bearing chamber 41 is a gas-liquid mixture fluid that contains the lubricating oil LO in a mist like form. Therefore, the gas-liquid mixture fluid that has flowed into the tank 144 is separated into a gas and a liquid in the tank 144. More specifically, the tank 144 has a gas-liquid separation function. The air is discharged from the tank 144, and is introduced into the gas-liquid separator 148. Furthermore, after the gas-liquid separation has been completed in the gas-liquid separator 148, the air is released into the atmosphere.

The supply pump 146 draws in the lubricating oil LO from the tank 144, and supplies the lubricating oil LO via a supply line 149 to the oil supply path 131 of the rotating electric machine housing 18. In this manner, the oil circulation supply device 140, together with supplying the lubricating oil LO to the oil supply path 131 of the rotating electric machine housing 18, carries out an oil circulation operation to recover the lubricating oil LO from the rotating electric machine housing 18, and to supply the lubricating oil LO again to the oil supply path 131.

As shown in FIGS. 2 and 3, the rotating electric machine system 12 further includes an oil scattering prevention cover 170. The oil scattering prevention cover 170 is provided in the first bearing chamber 39. The oil scattering prevention cover 170 covers the first bearing 38 so as to face the first bearing 38 in the axial direction. The oil scattering prevention cover 170 is fixed to the first sub-housing 21. Therefore, the oil scattering prevention cover 170 is a non-rotating member.

During operation of the rotating electric machine system 12, the lubricating oil LO delivered from the first oil nozzle 138 is repelled by the bearing rotating at high speed. Also, the lubricating oil LO delivered from the second oil nozzle 153 is repelled by the fastening ring 70 screwed onto the rotor 32 rotating at high speed. The oil scattering prevention cover 170 prevents the lubricating oil LO repelled in this manner from scattering in the first bearing chamber 39.

The oil scattering prevention cover 170 includes a base wall portion 172 and a circumferential wall portion 174. The base wall portion 172 faces toward the first bearing 38 in the axial direction of the rotating electric machine system 12. A through hole 173 is formed in the base wall portion 172. The rotor 32 is inserted through the through hole 173. The through hole 173 is a circular opening. The diameter of the through hole 173 is slightly larger than an outer diameter of the portion of the rotor 32 inserted into the through hole 173. Therefore, an annular gap is formed between an inner circumferential end of the base wall portion 172 (the end part forming the through hole 173) and the rotor 32. The circumferential wall portion 174 protrudes from the outer circumferential portion of the base wall portion 172 in the axial direction (X2 direction).

As shown in FIG. 3, the first oil nozzle 138 protrudes from the inner circumferential surface of the oil scattering prevention cover 170. The first oil nozzle 138 is connected to the circumferential wall portion 174. The first oil nozzle 138 is inserted into a first insertion hole 175a formed in the circumferential wall portion 174. The first delivery port 138a is disposed inside the oil scattering prevention cover 170.

The second oil nozzle 153 protrudes from the inner circumferential surface of the oil scattering prevention cover 170. The second oil nozzle 153 is connected to the circumferential wall portion 174. The second oil nozzle 153 is inserted into a second insertion hole 175b formed in the circumferential wall portion 174. The second delivery port 153a is disposed inside the oil scattering prevention cover 170. The first oil nozzle 138, the second oil nozzle 153, and the oil scattering prevention cover 170 may be a single component in which these components are integrally formed.

As shown in FIG. 2, the oil scattering prevention cover 170 has an opening portion 176 that opens downward. The opening portion 176 is formed in a lower part of the oil scattering prevention cover 170. The opening portion 176 guides the lubricating oil LO that has impinged on the inner surface of the oil scattering prevention cover 170 downward. Therefore, the lubricating oil LO flowing out from the oil scattering prevention cover 170 through the opening portion 176 is stored in the lower part of the first bearing chamber 39. The lubricating oil LO is sucked through the first oil discharge port 111 and discharged from the first bearing chamber 39.

The first oil discharge port 111 is disposed below the opening portion 176. As shown in FIGS. 2 and 7, the first oil discharge port 111 is disposed directly below the opening portion 176. The first oil discharge port 111 may be disposed at a position shifted in the horizontal direction from the position directly below the opening portion 176. The first oil discharge port 111 may be disposed in any position that enables the discharge port to draw in the lubricating oil LO.

As shown in FIG. 7, the first bearing chamber 39 is provided with a wall portion 186 that suppresses the entrainment and lifting (being carried upward) of the lubricating oil LO by the airflow (swirling airflow) generated in the first bearing chamber 39. The wall portion 186 is provided outside of the oil scattering prevention cover 170. The wall portion 186 protrudes from an inner circumferential surface 39s of the first bearing chamber 39 (the inner circumferential surface of the first sub-housing 21).

In the present embodiment, the wall portion 186 is a part of a suppressing member 180. The suppressing member 180 is fixed to the first sub-housing 21. The suppressing member 180 includes a fixed base portion 182, a supporting portion 184, and the wall portion 186. The fixed base portion 182 is fixed to the first sub-housing 21.

The supporting portion 184 is a portion bent with respect to the fixed base portion 182, and protrudes from the fixed base portion 182 in the axial direction. The supporting portion 184 supports the wall portion 186. The wall portion 186 is bent with respect to the supporting portion 184. The wall portion 186 protrudes from the supporting portion 184 toward the oil scattering prevention cover 170. The wall portion 186 may be provided on the oil scattering prevention cover 170. In this case, the wall portion 186 protrudes from the circumferential wall portion 174 of the oil scattering prevention cover 170 toward the inner circumferential surface 39s of the first bearing chamber 39.

Next, a description will be given concerning the gas turbine engine 14 shown in FIG. 1. Moreover, it should be noted that the configuration of the gas turbine engine 14, for example, is similar to the configuration shown in FIG. 7 of JP 2023-106078 A. Therefore, the description of the gas turbine engine 14 will be kept brief.

The gas turbine engine 14 is equipped with an engine housing 160. The engine housing 160 is connected to the rotating electric machine housing 18. The engine housing 160 includes a plurality of leg members 166. An air intake space is formed between the leg members 166.

As shown in FIG. 2, the gas turbine engine 14 includes an output shaft 168. A non-illustrated compressor wheel and a non-illustrated turbine wheel are mounted radially outward of the output shaft 168. The output shaft 168 is connected to the rotating shaft 58. The compressor wheel and the turbine wheel are capable of rotating integrally together with the rotating shaft 58 and the output shaft 168.

The gas turbine engine 14 may be a gas supply device 103 that supplies the air to the gaseous coolant flow path structure 102 (the sealing air flow path structure). In this case, a portion of the air that is generated by the rotation of the compressor wheel is extracted, and is supplied to the gas supply path 104 that is disposed in the first sub-housing 21. Moreover, the gas supply device 103 may be another compressor that compresses the atmosphere and supplies the same to the gas supply path 104. The cooling gas that is supplied to the gas supply path 104 may be a gas that is supplied from an oxygen cylinder, a nitrogen cylinder, or the like.

The combined motive power system 10 that is constituted as described above operates in the following manner.

First, by driving the rotating electric machine 16, the gas turbine engine 14 is started. When the gas turbine engine 14 starts, the rotor 32 of the rotating electric machine 16 rotates due to the rotational driving force of the output shaft 168 of the gas turbine engine 14, and electricity is generated in the rotating electric machine 16. In accordance with this feature, the combined motive power system 10 is placed in operation.

As shown in FIG. 6, during operation of the combined motive power system 10, air is supplied from the gas supply device 103 to the rotating electric machine housing 18. In accordance with this feature, the rotating electric machine 16, together with being cooled, is sealed by the air curtain. Further, the lubricating oil LO is supplied from the oil circulation supply device 140 to the oil supply path 131 of the rotating electric machine housing 18, and the lubricating oil LO is supplied to the first bearing 38 and the second bearing 40. In this case, as shown in FIG. 2, the first oil nozzle 138 delivers the lubricating oil LO toward the first bearing 38.

The lubricating oil LO is supplied from the oil circulation supply device 140 to the second oil nozzle 153, and the lubricating oil LO is delivered from the second oil nozzle 153 toward the rotor 32 (the inlet 631 of the rotor internal flow path 63). In accordance with this feature, the permanent magnets 61 are cooled by the lubricating oil LO that flows through the rotor internal flow path 63.

In this manner, the lubricating oil LO is delivered from the first oil nozzle 138 toward the first bearing 38, and the lubricating oil LO is delivered from the second oil nozzle 153 toward the rotor 32. In this case, the lubricating oil LO is repelled by the rotor 32 and the first bearing 38 rotating at high speed, but the oil scattering prevention cover 170 prevents the lubricating oil LO from scattering in the first bearing chamber 39. Specifically, the repelled lubricating oil LO impinges on the inner surface of the oil scattering prevention cover 170 (cover inner surface), flows down along the cover inner surface due to gravity, and reaches the oil reservoir region provided in the lower part of the first bearing chamber 39 via the opening portion 176. The lubricating oil LO is drawn in by the first oil discharge port 111, and is discharged from the first bearing chamber 39.

In the first bearing chamber 39, a swirling airflow is generated by the rotation of the rotor 32, but the wall portion 186 suppresses the entrainment and lifting of the lubricating oil LO. That is, since the wall portion 186 blocks the rise of the lubricating oil LO due to the swirling airflow, the lubricating oil LO can be retained in the lower portion of the first bearing chamber 39. The wall portion 186 also has a function of reducing the flow rate of the swirling airflow.

On the other hand, as shown in FIG. 6, the air is discharged, via the first gas discharge path 107, from the first bearing chamber 39. In this manner, the fluid inside the first bearing chamber 39 is separated into the lubricating oil LO and the air, and each of the lubricating oil LO and the air is discharged from the first bearing chamber 39. Stated otherwise, the first bearing chamber 39 function as a first gas-liquid separation unit. In the tank 144, the air that is discharged from the first bearing chamber 39 is introduced, and the gas-liquid separation is carried out again. Therefore, the tank 144 functions as a second gas-liquid separation unit. The air that is discharged from the tank 144 is again separated into a gas and a liquid by the gas-liquid separator 148. Therefore, the gas-liquid separator 148 functions as a third gas-liquid separation unit.

The present embodiment exhibits the following advantageous effects.

The rotating electric machine system 12 includes the oil scattering prevention cover 170 provided in the first bearing chamber 39. The first delivery port 138a of the first oil nozzle 138 is disposed inside the oil scattering prevention cover 170. In accordance with such a configuration, the lubricating oil LO repelled by the first bearing 38 rotating at high speed is prevented from scattering in the first bearing 38, and the entrainment and lifting of lubricating oil LO by the swirling airflow is suppressed. Therefore, the gas-liquid separation efficiency in the first bearing chamber 39 is improved, and the lubricating oil LO can be efficiently recovered. In addition, the load of the pump or the like used to recover the lubricating oil LO is reduced, which can contribute to the reduction in size and weight of the pump or the like.

Specifically, since the load of the recovery pump 142 is reduced, it is possible to contribute to the reduction in size and weight of the recovery pump 142. Further, since the gas- liquid separation function in the first bearing chamber 39 is improved, the tank 144 does not need to have a large gas-liquid separation function, which can contribute to the miniaturization of the tank 144. The improvement in the gas-liquid separation function in the first bearing chamber 39 can contribute to the reduction in size of the gas-liquid separator 148 disposed on the downstream side of the tank 144. Further, when the gas-liquid separation is sufficiently performed by the first bearing chamber 39 and the tank 144, the gas-liquid separator 148 may be omitted.

The first oil nozzle 138 protrudes from the inner circumferential surface of the oil scattering prevention cover 170. in accordance with such a configuration, since the first bearing 38 can be sufficiently covered with the oil scattering prevention cover 170 while the first delivery port 138a is disposed in the vicinity of the first bearing 38, it is possible to improve both the supply efficiency of the lubricating oil LO to the first bearing 38 and the function of oil scattering prevention.

The oil scattering prevention cover 170 includes the base wall portion 172 that faces the first bearing 38 in the axial direction, and the circumferential wall portion 174 that protrudes from the outer circumferential portion of the base wall portion 172 in the axial direction. In accordance with such a configuration, by favorably covering the first bearing 38 in the first bearing chamber 39, it is possible to effectively prevent the lubricating oil LO from scattering.

The first oil nozzle 138 is connected to the circumferential wall portion 174. In accordance with such a configuration, the first oil nozzle 138 and the oil scattering prevention cover 170 can be compactly disposed in the first bearing chamber 39.

The oil scattering prevention cover 170 has the opening portion 176 that opens downward. In accordance with such a configuration, the lubricating oil LO is collected in the lower portion of the first bearing chamber 39, and thus the lubricating oil LO can be efficiently recovered.

Below the opening portion 176, the first bearing chamber 39 is provided with the first oil discharge port 111 for discharging the lubricating oil LO from the first bearing chamber 39. In accordance with such a configuration, the lubricating oil LO that has been collected in the lower portion of the first bearing chamber 39 can be efficiently recovered.

As shown in FIG. 7, the first bearing chamber 39 is provided with the wall portion 186 that is disposed outside the oil scattering prevention cover 170 and that suppresses the entrainment and lifting of the lubricating oil LO by the airflow generated in the first bearing chamber 39. In accordance with such a configuration, the entrainment and lifting of the lubricating oil LO by the airflow generated in the first bearing chamber 39 is suppressed, and thus the lubricating oil LO collected in the lower portion of the first bearing chamber 39 can be more efficiently recovered.

The wall portion 186 protrudes from the inner circumferential surface of the first bearing chamber 39. In accordance with such a configuration, it is possible to effectively suppress the entrainment and lifting of the lubricating oil LO by the airflow generated in the first bearing chamber 39.

As shown in FIG. 3, the second oil nozzle 153 having the second delivery port 153a that delivers the lubricating oil LO toward the inlet 631 (FIG. 4) of the rotor internal flow path 63 is provided in the first bearing chamber 39. The second delivery port 153a is disposed inside the oil scattering prevention cover 170. In accordance with such a configuration, the permanent magnets 61 can be cooled by the lubricating oil LO supplied into the rotor 32. Further, the lubricating oil LO can be efficiently recovered by preventing the lubricating oil LO repelled by the surrounding portion of the inlet 631 of the rotor internal flow path 63 from scattering.

As shown in FIG. 6, the oil circulation supply device 140 recovers the lubricating oil LO discharged from the rotating electric machine housing 18 via the first oil discharge port 111 and the cooling gas (air) discharged from the rotating electric machine housing 18 via the first gas discharge path 107, by the tank 144. The oil circulation supply device 140 supplies again the lubricating oil LO recovered by the tank 144 to the oil supply path 131 of the rotating electric machine housing 18. In accordance with such a configuration, the lubricating oil LO and the cooling gas are separated from each other in the first bearing chamber 39, and thus it is possible to reduce the load of the pumps and the like (the recovery pump 142, the tank 144, the supply pump 146, and the gas-liquid separator 148) used for recovering the lubricating oil LO. In addition, since the lubricating oil LO mixed in the second gas discharge path 108 can be recovered to the tank 144 by the flow of the cooling gas, the recovery efficiency of the lubricating oil LO can be improved.

The following supplementary notes are further disclosed in relation to the above embodiment.

### Supplementary Note 1

The rotating electric machine system (12) according to the present disclosure includes the rotating electric machine (16) including the rotor (32), the rotor including the permanent magnet (61) and the rotating shaft (58), the rotating electric machine housing (18) configured to rotatably support the rotating shaft, the first bearing (38) and the second bearing (40) each interposed between the rotating electric machine housing and the rotating shaft, and configured to be mutually spaced apart from each other in the axial direction of the rotor, the first bearing chamber (39) provided in the rotating electric machine housing and configured to accommodate the first bearing, the first oil nozzle (138) provided in the first bearing chamber and including the first delivery port (138a) through which the lubricating oil (LO) is delivered toward the first bearing, the oil circulation supply device (140) configured to recover the lubricating oil from the first bearing chamber and supply the lubricating oil to the oil supply path (131) provided in the rotating electric machine housing, and the oil scattering prevention cover (170) provided in the first bearing chamber and configured to cover the first bearing so as to face the first bearing in the axial direction, wherein the first delivery port is disposed inside the oil scattering prevention cover. In accordance with such a configuration, the lubricating oil that is repelled by the first bearing rotating at a high speed is prevented from scattering in the first bearing, and the entrainment and lifting of the lubricating oil by the swirling airflow accompanying the rotation of the rotor is suppressed. Therefore, the gas-liquid separation efficiency in the first bearing chamber is improved, and the lubricating oil can be efficiently recovered. In addition, the load of the pump or the like used to recover the lubricating oil is reduced, which can contribute to the reduction in size and weight of the pump or the like.

### Supplementary Note 2

In the rotating electric machine system according to Supplementary Note 1, the first oil nozzle may protrude from the inner circumferential surface of the oil scattering prevention cover. In accordance with such a configuration, since the first bearing can be sufficiently covered with the oil scattering prevention cover while the first delivery port is disposed in the vicinity of the first bearing, it is possible to improve both the supply efficiency of the lubricating oil to the first bearing and the function of oil scattering prevention.

### Supplementary Note 3

In the rotating electrical machine system according to Supplementary Note 1, the oil scattering prevention cover may include the base wall portion (172) configured to face the first bearing in the axial direction, and the circumferential wall portion (174) configured to protrude from the outer circumferential portion of the base wall portion in the axial direction. In accordance with such a configuration, by favorably covering the first bearing in the first bearing chamber, it is possible to effectively prevent the lubricating oil from scattering.

### Supplementary Note 4

In the rotating electric machine system according to Supplementary Note 3, the first oil nozzle may be connected to the circumferential wall portion. In accordance with such a configuration, the first oil nozzle and the oil scattering prevention cover can be compactly disposed in the first bearing chamber.

### Supplementary Note 5

In the rotating electric machine system according to Supplementary Note 1, the oil scattering prevention cover may include the opening portion (176) configured to open downward. In accordance with such a configuration, the lubricating oil is collected in the lower portion of the first bearing chamber, and thus the lubricating oil can be efficiently recovered.

### Supplementary Note 6

In the rotating electric machine system according to Supplementary Note 5, the first bearing chamber may be provided with the oil discharge port (111) below the opening portion, and the lubricating oil may be discharged from the first bearing chamber through the oil discharge port. In accordance with such a configuration, the lubricating oil that has been collected in the lower portion of the first bearing chamber can be efficiently recovered.

### Supplementary Note 7

In the rotating electric machine system according to Supplementary Note 1, the first bearing chamber may be provided with the wall portion (186) disposed outside the oil scattering prevention cover, the wall portion being configured to suppress the entrainment and lifting of the lubricating oil by the airflow generated in the first bearing chamber. In accordance with such a configuration, the entrainment and lifting of the lubricating oil by the airflow generated in the first bearing chamber is suppressed, and thus the lubricating oil collected in the lower portion of the first bearing chamber can be more efficiently recovered.

### Supplementary Note 8

In the rotating electric machine system according to Supplementary Note 7, the wall portion may protrude from the inner circumferential surface of the first bearing chamber. In accordance with such a configuration, it is possible to effectively suppress the entrainment and lifting of the lubricating oil by the airflow generated in the first bearing chamber.

### Supplementary Note 9

In the rotating electric machine system according to Supplementary Note 1, the rotor internal flow path (63) through which the lubricating oil is allowed to flow may be formed in the interior of the rotor, the rotor may include the inlet (631) of the rotor internal flow path, the inlet of the rotor internal flow path may open in the first bearing chamber, the second oil nozzle (153) including the second delivery port (153a) through which the lubricating oil is delivered toward the inlet may be provided in the first bearing chamber, and the second delivery port may be disposed inside the oil scattering prevention cover. In accordance with such a configuration, the permanent magnet can be cooled by the lubricating oil supplied into the rotor. Further, the lubricating oil can be efficiently recovered by preventing the lubricating oil repelled by the surrounding portion of the second delivery port from scattering.

### Supplementary Note 10

In the rotating electric machine system according to any one of Supplementary Notes 1 to 9, the rotating electric machine housing may include the gas supply path (104) through which the cooling gas is supplied into the rotating electric machine housing, and the gas discharge path (107) through which the cooling gas is discharged from the first bearing chamber, and the oil circulation supply device may include the tank (144) configured to recover the lubricating oil discharged from the rotating electric machine housing via the oil discharge path and the cooling gas discharged from the rotating electric machine housing via the gas discharge path, and the oil circulation supply device may resupply the lubricating oil recovered by the tank to the oil supply path of the rotating electric machine housing. In accordance with such a configuration, the lubricating oil and the cooling gas are separated from each other in the first bearing chamber, and thus it is possible to reduce the load of the pumps and the like used for recovering the lubricating oil. In addition, since the lubricating oil mixed in the gas discharge path can be recovered to the tank by the flow of the cooling gas, the recovery efficiency of the lubricating oil can be improved.

Although the present disclosure has been described in detail, the present disclosure is not necessarily limited to the specific embodiments described above. These embodiments can be subjected to various additions, substitutions, modifications, partial deletions and the like, within a range that does not depart from the essence and gist of the present disclosure, or alternatively, the purpose and gist of the present disclosure as derived from the contents described in the claims and their equivalents. Further, these embodiments can also be implemented in combination. For example, in the above-described embodiments, the order of the operations and the order of the processes are shown merely as examples, and the present invention is not necessarily limited to these examples. Further, the same also applies to cases in which numerical values or mathematical expressions are used in the description of the aforementioned embodiments.

1. A rotating electric machine system, comprising:
a rotating electric machine including a rotor, the rotor including a permanent magnet and a rotating shaft;
a rotating electric machine housing configured to rotatably support the rotating shaft;
a first bearing and a second bearing each interposed between the rotating electric machine housing and the rotating shaft, and configured to be mutually spaced apart from each other in an axial direction of the rotor;
a first bearing chamber provided in the rotating electric machine housing and configured to accommodate the first bearing;
a first oil nozzle provided in the first bearing chamber and including a first delivery port through which a lubricating oil is delivered toward the first bearing;
an oil circulation supply device configured to recover the lubricating oil from the first bearing chamber and supply the lubricating oil to an oil supply path provided in the rotating electric machine housing; and
an oil scattering prevention cover provided in the first bearing chamber and configured to cover the first bearing so as to face the first bearing in the axial direction,
wherein the first delivery port is disposed inside the oil scattering prevention cover.

2. The rotating electric machine system according to claim 1, wherein the first oil nozzle protrudes from an inner circumferential surface of the oil scattering prevention cover.

3. The rotating electric machine system according to claim 1, wherein the oil scattering prevention cover includes a base wall portion configured to face the first bearing in the axial direction, and a circumferential wall portion configured to protrude from an outer circumferential portion of the base wall portion in the axial direction.

4. The rotating electric machine system according to claim 3, wherein the first oil nozzle is connected to the circumferential wall portion.

5. The rotating electric machine system according to claim 1, wherein the oil scattering prevention cover includes an opening portion configured to open downward.

6. The rotating electric machine system according to claim 5, wherein the first bearing chamber is provided with an oil discharge port below the opening portion, and the lubricating oil is discharged from the first bearing chamber through the oil discharge port.

7. The rotating electric machine system according to claim 1, wherein the first bearing chamber is provided with a wall portion disposed outside the oil scattering prevention cover, the wall portion being configured to suppress entrainment and lifting of the lubricating oil by an airflow generated in the first bearing chamber.

8. The rotating electric machine system according to claim 7, wherein the wall portion protrudes from an inner circumferential surface of the first bearing chamber.

9. The rotating electric machine system according to claim 1, wherein a rotor internal flow path through which the lubricating oil is allowed to flow is formed in an interior of the rotor,
the rotor includes an inlet of the rotor internal flow path,
the inlet of the rotor internal flow path opens in the first bearing chamber,
a second oil nozzle including a second delivery port through which the lubricating oil is delivered toward the inlet is provided in the first bearing chamber, and
the second delivery port is disposed inside the oil scattering prevention cover.

10. The rotating electric machine system according to claim 1, wherein the rotating electric machine housing includes a gas supply path through which a cooling gas is supplied into the rotating electric machine housing, and a gas discharge path through which the cooling gas is discharged from the first bearing chamber, and
the oil circulation supply device includes a tank configured to recover the lubricating oil discharged from the rotating electric machine housing via an oil discharge path and the cooling gas discharged from the rotating electric machine housing via the gas discharge path, and the oil circulation supply device resupplies the lubricating oil recovered by the tank to the oil supply path of the rotating electric machine housing.
